(19) United States
(12) Patent Application Publication
(10) Pub. No.: US 2006/0060114 A1
(43) Pub. Date: Mar. 23, 2006

(54) Security safe

(76) Inventor: James T. Walker, Los Angeles, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/270,992

(22) Filed: Nov. 11, 2005

Related U.S. Application Data
(63) Continuation-in-part of application No. 09/727,640, filed on Nov. 30, 2000, now abandoned.

(51) Int. Cl. E06B 7/00

(52) U.S. Cl. 109/67

(57) ABSTRACT

A security safe having a housing defining a security enclosure, the housing including an opening into an interior of said enclosure for placing items into, and removing items from, said enclosure. A door mechanism is mounted to the housing for movement between opened and closed positions in relation to said opening, wherein in the closed position the door mechanism precludes access to said interior through said opening. In one version, the housing further includes an aperture for inserting items into said enclosure without moving said door mechanism into the opened position. In another version the aperture is defined in a door of the safe. The enclosure further includes a breach providing access into the safe for passing at least a power cable therethrough for powering at least one electrical unit therein.

### RELATED APPLICATIONS

This application is a Continuation-in-Part of U.S. patent application Ser. No. 09/757,640, filed Nov. 30, 2000, and this application also claims the benefit of priority under 35 U.S.C. § 120 of U.S. Design application Ser. No. 29/215,235 filed Oct. 16, 2004, Serial No. 29/215,236 filed Oct. 16, 2004, Ser. No. 29/215,237 filed Oct. 16, 2004 and Ser. No. 29/215,268 filed Oct. 16, 2004.

### FIELD OF THE INVENTION

The present invention relates in general to enclosures for protecting valuables, and in particular to lock boxes for universities and colleges.

### BACKGROUND OF THE INVENTION

There has been a need for safe boxes in public and semi-public locations. For example, in universities, with the proliferation of electronic devices such as laptop computers, cell phones and the like, many students find the need for a way to securely store their electronic equipment and other valuables. Many students in schools and universities use laptop computers, and increasingly many education institutions require the students to have laptops. Some universities provide lockers near class rooms wherein a student can store objects in a locker. However, such lockers have many disadvantages. There usually are less lockers available than the number of students who need lockers. The locker door must be opened and closed every time an item is placed, or removed from the locker. Further, onlookers can see the valuable items being placed into or removed from a locker, and contents of the locker are exposed to public view every time the locker is opened. This poses a privacy and security risk. Further, for students living in dormitory rooms, currently there are no means of securely storing valuables such as laptops, cell phones, money, jewelry, etc., in the dormitory rooms. Theft from dormitory rooms is common, and often dormitory rooms are shared, thereby increasing the risk of theft.

There is, therefore, a need for a safe box for storing objects such as valuables in public and semi-public locations such as university dormitory rooms. There is also a need for such a safe box to allow placing objects into the safe box without exposing the contents of the safe box. There is also a need for such a safe box to allow securing the safe box to prevent removal.

### SUMMARY OF THE INVENTION

The present invention satisfies these needs. In one embodiment, the present invention provides a security safe having a housing defining a security enclosure, the housing including an opening into an interior of said enclosure for placing items into, and removing items from, said enclosure. A door mechanism is mounted to the housing for movement between opened and closed positions in relation to said opening, wherein in the closed position the door mechanism precludes access to said interior through said opening. In one version, the housing further includes an aperture for inserting items into said enclosure without moving said door mechanism into the opened position. In another version, the aperture is defined in a door of the safe. The safe includes means for locking the doors, and anchoring means for anchoring the safe to a structure. In another embodiment the safe includes breaches/holes providing access into the safe for passing at least a power cable therethrough for powering at least one electrical unit therein.

These and other features, aspects and advantages of the present invention will become better understood with regard to the following description, appended claims and accompanying drawings.

### BRIEF DESCRIPTION OF THE DRAWINGS

FIG. 1 shows an example perspective view of an embodiment of a safe according to the present invention with the safe doors in the closed position.

FIG. 2 shows an example perspective view of the safe of FIG. 1 with the safe doors in the open position.

FIG. 3 shows an example perspective view of the safe of FIG. 1 with the safe doors removed, showing an example shelving for storage compartments within the safe.

FIG. 4 shows a partial top view of the safe of FIG. 1.

FIG. 5 shows a front view of the safe of FIG. 1.

FIG. 6 shows an example perspective view of another embodiment of a safe according to the present invention with the safe door in the closed position.

FIG. 7 shows a side view of the safe of FIG. 6.

FIG. 8 shows an example perspective view of the safe of FIG. 6 with the safe door opened, showing an example of shelving for storage compartments within the safe.

FIG. 9 shows a partial view of the inside of safe of FIG. 6.

FIG. 10 shows another partial perspective view of the inside of safe of FIG. 6.

FIG. 11 shows an example of breach (port hole) into the side of the safe of FIG. 6.

FIG. 12 shows another perspective of an example of breach (port hole) into the side of the safe of FIG. 6.

FIG. 13 shows an example perspective view of the safe of FIG. 6 with the safe door removed and showing example shelving and storage compartments, fastening mechanism and fasteners.

FIG. 14 shows a side view of safe of FIG. 6 with wall removed showing example shelving, compartments and locking bolts.

FIG. 15 shows a front/top view of safe of FIG. 6 with dry eraser board.

FIG. 16 shows a front/top view of safe of FIG. 6 with electronic eraser board.

### DETAILED DESCRIPTION OF THE INVENTION

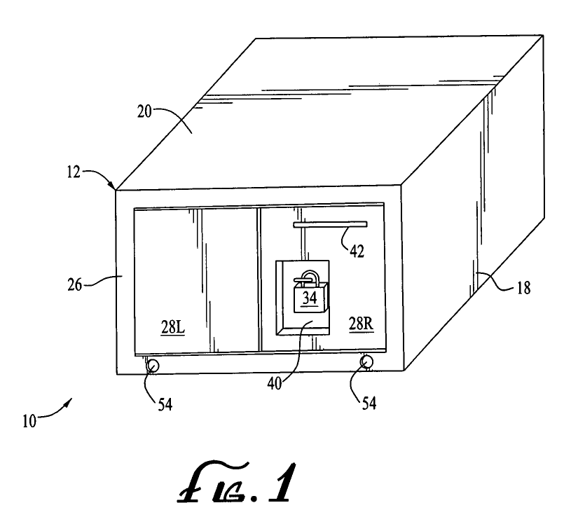

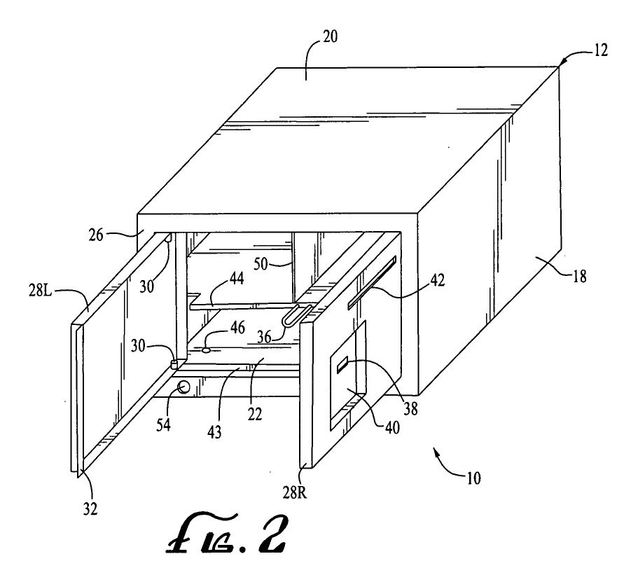

FIGS. 1-2 show perspectives view of an example embodiment of a safe 10 according to the present invention for securely storing valuables therein. The safe 10 comprises a housing 12 defining an enclosure 14, with an access-opening 16 providing access to the interior of the housing 12 for storing objects such as valuables. The housing 12 includes side walls 18, top wall 20, bottom wall 22 and rear wall 24, and said access-opening 16 and a door mechanism 28 including one or more doors form a front wall 26 of the safe 10. Preferably, the door mechanism 28 includes two doors 28L and 28R as shown, wherein the doors 28L, 28R are attached to the housing 12 around the opening 16 using hinges 30 as shown in FIGS. 2 and 4. The hinges 30 are selected, and the doors 28L, 28R are attached to the housing 12 via the hinges 30, such that when the doors 28L, 28R are closed, the hinges 30 are not visible (FIG. 1). This provides a flush external surface for the safe 10 where the doors 28L, 28R are attached to the housing 12, and prevents removal of the doors 12 by manipulating the hinges 30 when the doors 28L, 28R are closed.

In one example, the safe 10 has outside dimensions of about e.g. 10″ high.times.17″ wide.times.12.5″ deep. The access-opening 16 is defined on the front wall 26 of the safe 10, wherein the access-opening 16 is about e.g. 8″ high.times.15″ wide. The housing 12 and the doors 28L, 28R are made from e.g. 18 Gauge steel that has a baked power coat finish. Other dimensions and rigid materials for the safe 10 are possible and contemplated by the present invention. Access to the safe 10 is controlled with the two outward swinging doors 28L, 28R that pivot on the concealed hinges 30.

The safe 10 includes a locking mechanism for locking the doors 28R, 28L closed. In one example, the right hand (second) door 28R traps the left hand (first) door 28L when closed, if the left hand door 28L is closed first. For example, the left hand door 28L can include a lip 32 extending from an edge of the door 28L, whereby the right hand door 28R traps the left door 28L as shown in FIG. 4. In this embodiment, the right hand door 28R is controlled in its opening and closing using a padlock 34 inserted through a member such as steel loop 36 that is welded to the inside of the housing 12 and projects through a breach 38 in the right hand door 28R, wherein the padlock can be placed through the hoop 36, preventing the doors 28L, 28R from being opened without removing the padlock. In this example, the hoop 36 is attached to a divider 44 secured inside the housing 12. Other locking mechanisms for the safe 10 are possible (e.g., combination lock) and contemplated by the present invention.

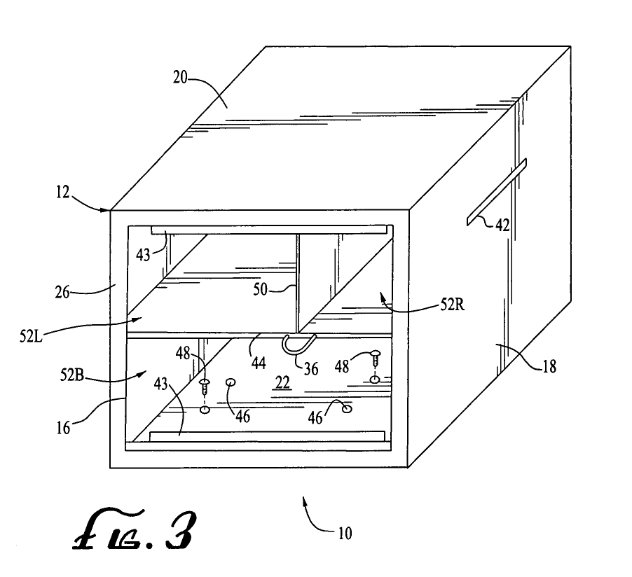

The right hand door 28R includes a recessed area 40 on the face of the right hand door 28R, wherein the breach 38 is defined in the recess 40 to provide an area for the padlock and a flush face to the safe. The hoop 36 projects through the breach 38 into the recessed area 40 (FIG. 4). As shown in FIG. 3, the doors 28L, 28R can be disassembled from the housing 12, when the doors 28L, 28R are open, by means of hand tools. This allows repairing or changing the doors 28L, 28R. Each door 28L, 28R is about e.g. 8″ high.times.7.5″ wide. The recessed area 40 on the right hand door 28R can be rectangular, about e.g. 4″ high.times.3″ wide.times.0.5″ deep. The breach 38 in the recessed area 40 can be about e.g. 1″ from top of the recess 40 and about 1″ wide. The housing 12 further includes lips 43 protruding from the opening 15, and recessed into the housing by e.g. 0.5 inches″, as door stops when the doors 28L, 28R are closed.

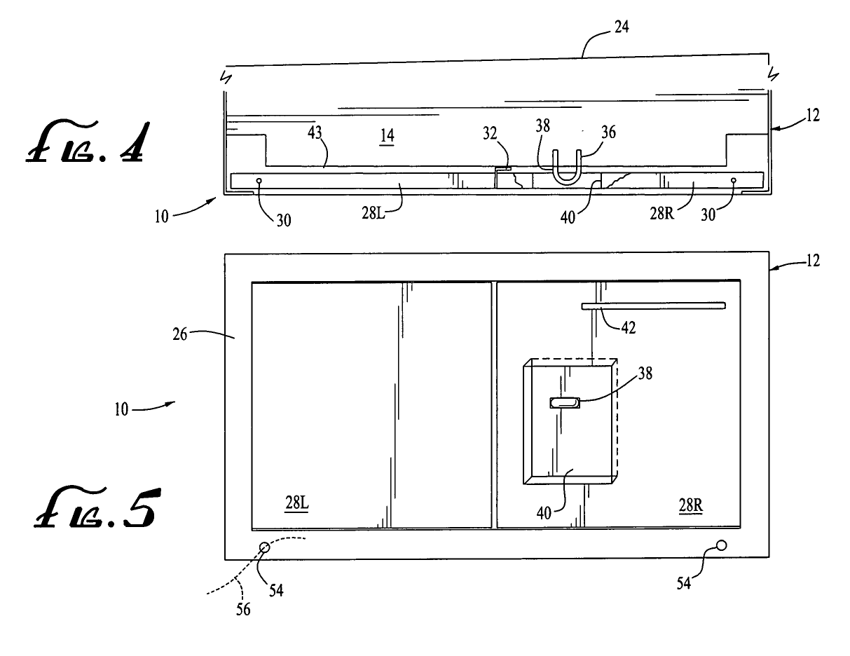

In another aspect of the present invention, the safe 10 further includes at least one aperture 42 for inserting items into the safe 10 without using said access-opening 16. As such, the aperture 42 can be used to insert items into the safe 10 without moving the doors 28 into the opened position. In one example shown in FIG. 5, the aperture 42 comprises a narrow horizontal slot defined in the right hand door 28R, wherein the slot is about e.g. ¼″ high and 5″ wide near the upper portion of the face of a door 28L or 28R. Other shapes, sizes and locations for the aperture 42 are possible and contemplated by the present invention. In another example shown in FIG. 3, the aperture 42 is defined in the housing 12, such as e.g. a side wall 18 of the housing 12. Preferably, the slot 42 is shaped and sized to allow inserting items into the safe 10, while preventing access to the interior 14 of the safe 10 for removing items therefrom when the safe doors 28L, 28R are closed. For example, the slot 42 can be used to insert items such as money, credit cards, mail, etc. into the safe 10 without opening the safe doors 28.

The safe 10 further includes an anchoring mechanism for securely fastening the safe to a structure, such as floor or walls boards, such that the safe 10 cannot be moved when the safe doors are closed. As shown in FIG. 3, in one example, the anchoring mechanism includes a plurality of orifices or holes 46 in the housing 12 to allow attachment of the safe 10 to a structure with fasteners 48, such that the fasteners cannot be removed when the doors 28L, 28R are in the closed position. For example, the safe 10 can be installed and anchored in the a student's dorm room using e.g. ¼″ anchor holes 46 in the bottom wall 22 of the housing 12 using fasteners 48 such as screws, nails, etc. The screws/nails 48 are inaccessible when the safe doors 28L, 28R are closed (FIG. 1). Other means of anchoring the safe 10 are possible and contemplated by the present invention.

As shown by example in FIG. 3, dividers/shelves 44, 50 are used to divide the interior space 14 in the safe into different storage area or compartments 52 (e.g., 52L, 52R, 52B). In the example of FIG. 3, dividers 44, 50 secured to the housing 12 (e.g., screwed) are used to define three storage areas 52L, 52R, 52B, wherein a horizontal shelf 44 divides the interior 14 in half into lower/bottom storage area 52B, and an upper area further divided by a vertical divider 50 into two unequal areas, a left area 52L and a right area 52R (e.g., area for the receipt of items inserted though said horizontal slot 42). The left hand upper interior portion 52L of the safe 10 can hold cameras, CD players, cell phones, and similar size personal items. The lower portion 52B of the safe 10 is designed to accommodate at least one portable or notebook personal computers.

As shown in FIG. 5, the safe 10 further includes one or more breaches/holes 54 providing access into the safe 10 for passing at least a power cable 56 therethrough for powering at least one electrical unit (e.g., notebook personal computer) in the safe 10 from an external power source when the doors 28L, 28R are closed. In the example shown, the breaches 54 are defined in the housing 12 (e.g., defined in the front wall 26 of the housing 12), and have a circular shape of about 1″ in diameter. Other shapes, sizes and locations for the breaches 54 are possible and contemplated by the present invention.

A safe 10 according to the present invention can be used in private, semi-public, and public locations. For example, the safe 10 can be used in homes, hotels, vehicles, and education institutions such as dormitory rooms. With the proliferation of the notebook personal computer, theft of such items has become more important to students. Currently students have no way of storing their notebook computers and valuables and small expensive items in their dorm room. As such, the students have no choice but to carry all of their valuables around with them at all times. An example safe 10 according the present invention takes little space in crowded dorm rooms, and can be locked by a lock such as a padlock or combination lock. Preferably, the student provides a lock which only the student can unlock. The lock can also be integrated into the safe 10. However, integrated mechanical combination locks or digital keypads can create a control/administration overhead for university management. The changing of codes for each student every semester can be difficult and time consuming. A lock provided by a student prevents management access to the student's belongings stored in the safe.

Students can store their belongings such as notebook computers, mail, cell phones, CD players, and other high value small items in the safe 10 in their dorm rooms, whereby the students total control over the contents of the safe 10 using the student's own lock. The student can conveniently deposit money and letters into the safe 10 using the drop aperture 42 without opening the safe doors 28L, 28R exposing contents of the safe 10. The safe 10 is designed for maximum space utilization and provides secure and private storage without using too much of the student's limited dorm room space. The inside shelf surfaces of the safe 10 can be covered with a rubber type material.

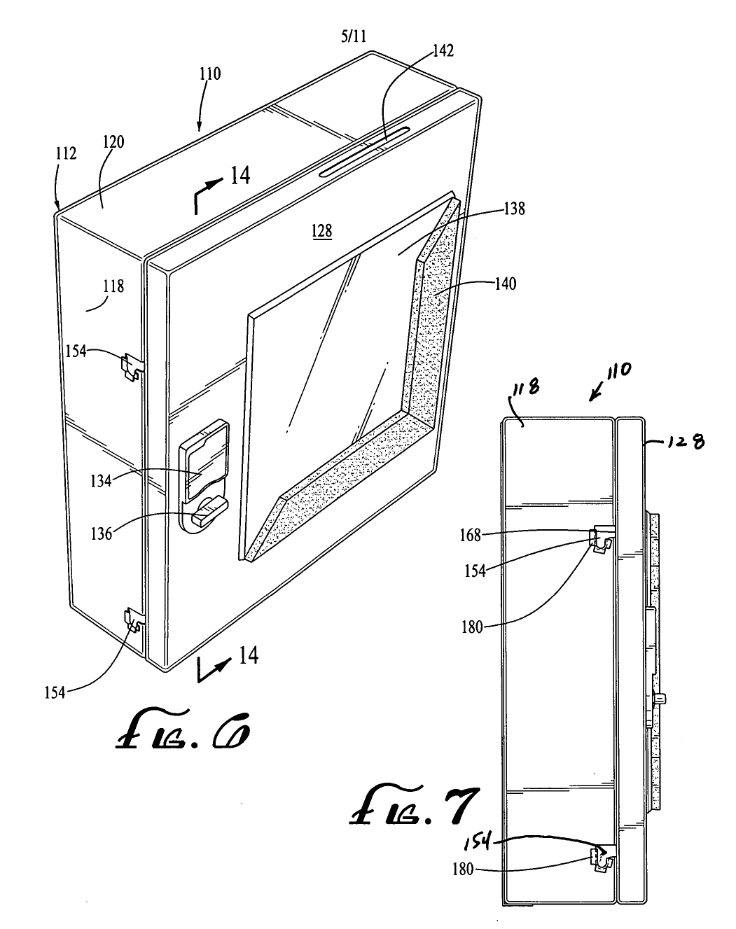

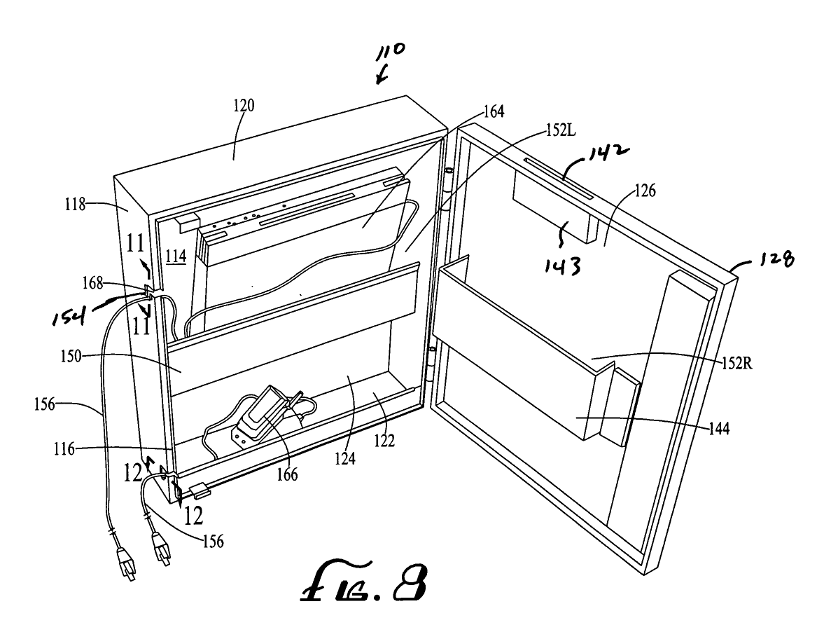

Referring now to FIGS. 6-16, another example safe 110 according to another embodiment the present invention is shown, for securely storing valuables therein. The safe 110 (FIG. 6) comprises a housing 112 defining an enclosure 114 (FIG. 8), with an access-opening 116 providing access to the interior of the housing 112 for storing objects therein. The housing 112 includes side walls 118, top wall 120, bottom wall 122 and rear wall 124, and said access-opening 116 and a door mechanism 128 including one door to form a front wall 126 of the safe 110.

In one example, the safe 110 has outside dimensions of about e.g. 19.8″ high×18″ wide×5.5″ deep. The access opening 116 is about e.g. 18″ high×17″ wide. The housing 112 and the door 128 are made from e.g. 18 gauge steel that has a baked powder coat finish. Other dimensions and rigid materials for the safe 110 are possible and contemplated by the present invention. Access to the safe 110 is controlled with the outward swinging of the door 128 that pivots on hinges 130 (FIG. 13).

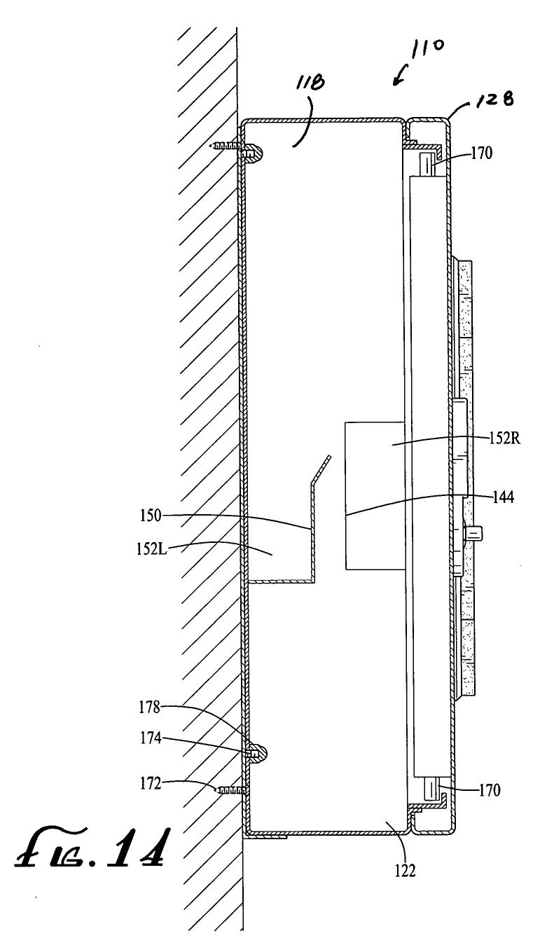

The safe 110 includes a locking mechanism for locking the door 128 closed. In one example, the door 128 is secured to the housing 112 by means of a locking mechanism including a digital keypad 134 and handle 136. The correct code is pressed on the digital keypad 134 and the handle 136 is turned, locking or unlocking steel bolts 170 (FIG. 14) concealed into the door 128 to the housing 112. Other locking mechanisms for the safe 110 are possible (e.g., combination lock, pad lock, etc.) and contemplated by the present invention.

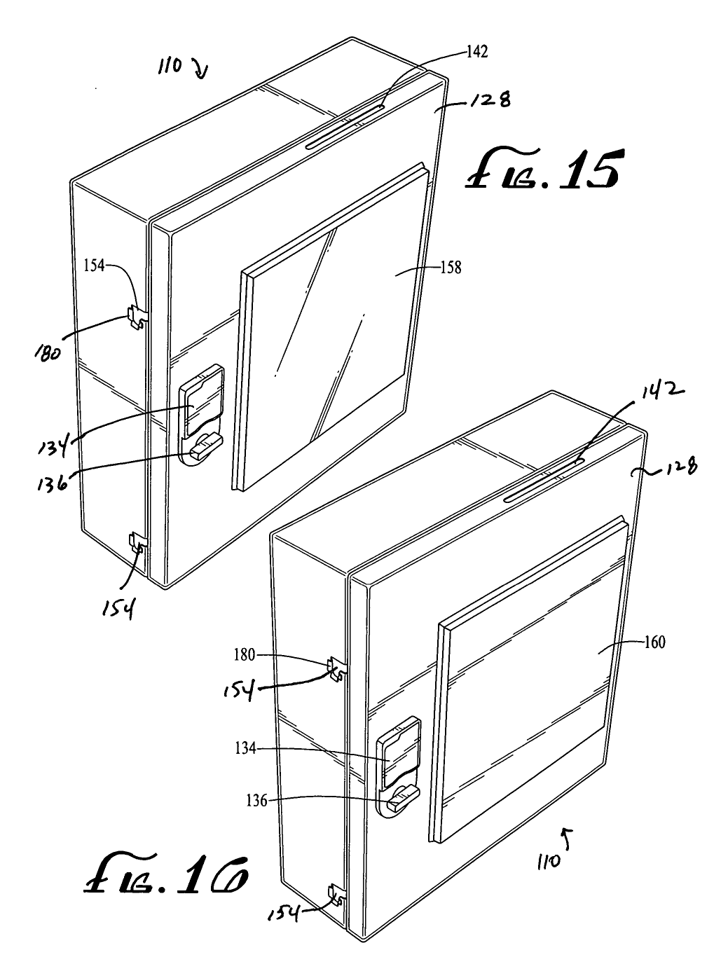

In one embodiment, the door 128 also includes one or more of: a corkboard 140, mirror 138, dry eraser board 158 (FIG. 15), electronic eraser board 160 (FIG. 16), or a combination thereof. In this example, the outside of the door 128 shows a mirror 138 and corkboard 140 affixed to the door 128.

In another aspect of the present invention, the safe 110 further includes at least one aperture 142 (FIG. 1) for inserting items into the safe 110 without using said access-opening 116. As such, the aperture 142 can be used to insert items into the safe 110 without moving the door 128 into the opened position. In one example, the aperture 142 comprises a narrow horizontal slot defined in the top part of the door 128, wherein the slot is about e.g. 0.25″ wide and 5″ long on the top of the door 128. Other shapes, sizes and locations for the aperture 142 are possible and contemplated by the present invention. Preferably, the slot 142 is shaped and sized to allow inserting items into the safe 110, while preventing access to the interior 114 of the safe 110 for removing items therefrom when the safe door 128 is closed. For example, the slot 142 can be used to insert items such as money, credit cards, mail etc., into the safe 110 without opening the safe door 128. Further, the slot 142 is positioned on the safe 110 to allow insertion of items (e.g., CDs, DVDs, etc.) into the safe without damage because a separate compartment or shelf 144 (FIG. 8) with a base/bottom is positioned for safely receiving and holding these items. A chute 143 guides items inserted in aperture 142 to drop into compartment/shelf 144. The compartment 144 is attached to the inside of the door 128 and positioned under the slot 142 to safely “catch” items that are dropped into the safe from the slot 142.

In another embodiment, the safe 110 further includes an anchoring mechanism 162 (FIG. 13) for securely fastening the safe 110 to a structure (e.g., a wall) with fasteners 172, such that safe 110 cannot be removed when the safe door 128 is closed. In one example, the anchoring mechanism 162 includes welded studs 174 and a corresponding plurality of orifices or holes 176 in the rear wall 124 of the housing 112 to allow attachment of the safe 110 to a structure with fasteners 178 such that the fasteners 178 cannot be removed when the door 128 is in the closed position. For example, the safe 110 can be installed and anchored in a student's dorm room or residence using ¼″ anchor holes in the back wall 124 of the housing 112 using fasteners such as screws, nails, etc. The screws/nails are inaccessible when the safe door 128 is closed. Other means of anchoring the safe 110 are possible and contemplated by the present invention.

As shown by example in FIGS. 8 and 14, dividers/shelves/compartments 144, 150 are used to divide a portion of the interior space 114 in the safe into different storage areas or compartments (e.g., shelving compartment areas 152L, 152R, bottom 122 of the safe, etc.). In the example of FIGS. 8 and 14, compartments 144, 150 are secured to the housing 112 (e.g. welded, screwed, etc.) and define the two storage areas 152L, 152R, respectively. The bottom 122 of the safe provides another storage surface. As discussed, the compartment 144 is attached to the inside of the door 128 for items to land safely in compartment 152R after insertion in the aperture 142 in the door 128 of the safe. The divider/shelf 150 is designed to accommodate in storage area 152L at least one electronic/electrical device such as a laptop or portable (e.g., notebook) personal computer 164. The bottom 122 of safe 110 is designed to hold other electrical devices such as digital cameras, cell phones 166, MP3 players, or other electronic devices.

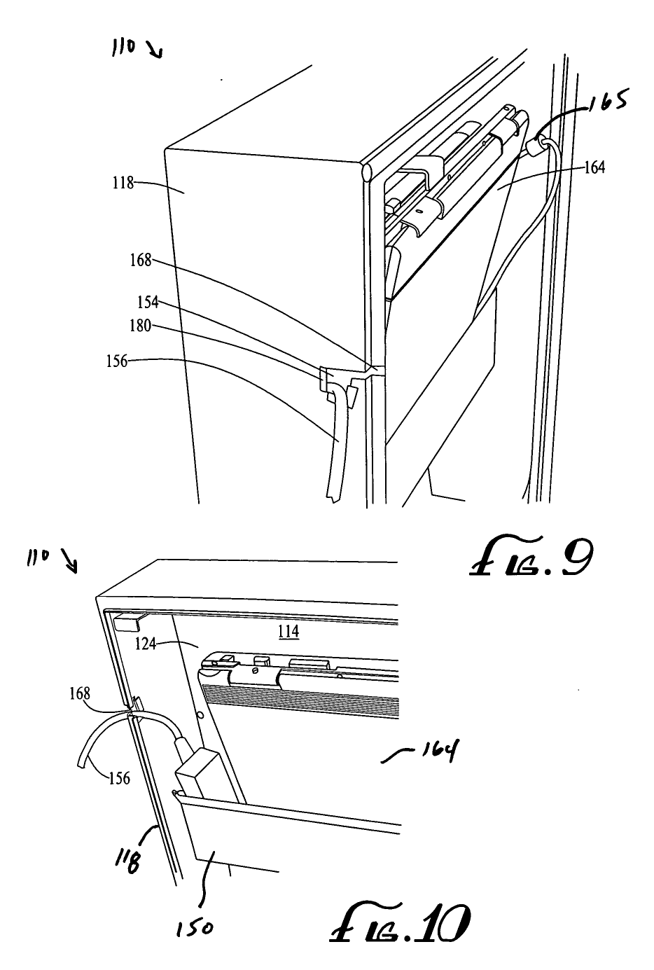

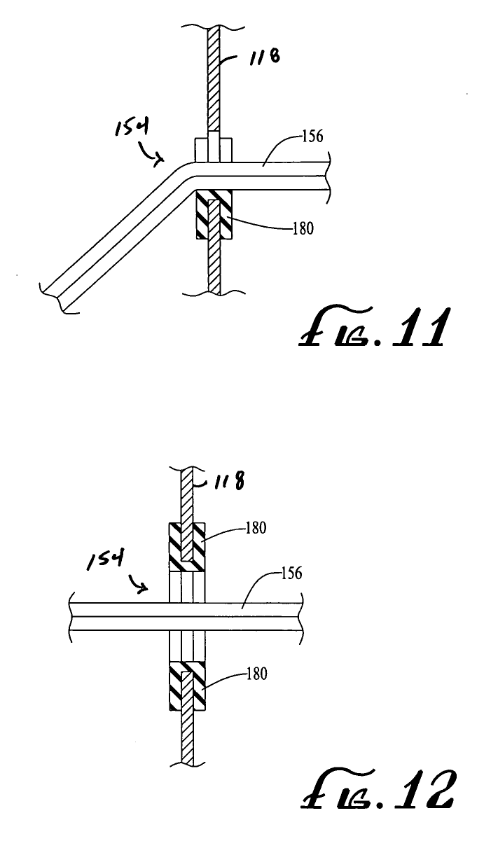

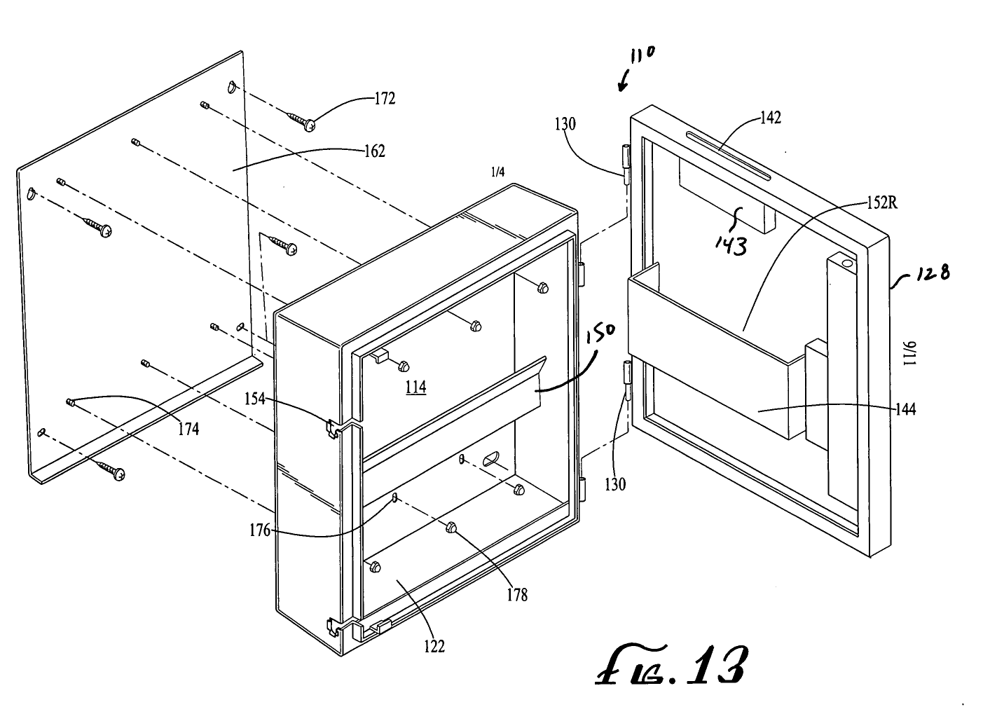

The safe 110 further includes one or more breaches/holes 154 (FIGS. 6-13,15 16) providing access into the safe 110 for passing at least a power cable 156 therethrough for powering at least one electrical unit (e.g., laptop or notebook personal computer 164) in the safe 110 from an external power source when the door 128 is in the closed position. In one example, the breaches 154 are defined in the housing 112 (e.g., defined in the side wall 118 of the housing 112) and are open ended, allowing for the power cable 156 to slide (be “dropped”) into each breach 154 from the open end 168 of the breach 154 (FIG. 9), and then to be enclosed when the door 128 is in the closed position (FIG. 7). When the door 128 is closed, the open end 168 of the breach 154 is blocked as shown in FIG. 7. In FIGS. 7 and 9 the breaches 154 are shown defined as L shaped and about ⅛″ in width, and FIG. 11 shows a rubber gramut or edge shield 180 extending ¾ the way around periphery of the breach 154 to prevent fraying of cord 156. FIG. 12 shows rubber gramut or edge shield 180 going fully around periphery of the breach 154. These breaches 154 allow at least a power cable 156 into the interior 114 of the safe 110 without compromising the security of the safe as the breach 154 needs only be as large as the power cable and does not have to accommodate what is attached to the end of the power cable (e.g., noise suppressors, couplings, radio frequency interceptors 165, etc.) which may otherwise make the opening or breach into the safe large enough for an intruder to remove small items (e.g., money, jewelry, etc.). In addition the power cord 156 can be connected to the electrical unit (e.g., laptop or personal computer 164, cell phone 166, etc.) outside of the safe 110 and the electrical unit can then be placed in the safe 110 with the cord 156 entering the open end 168 of the breach 154 and then sliding into the L-shaped breach 154 and protected by the rubber gramut or edge protector 180 (FIG. 9), wherein the door 128 then encloses and secures the power cord 156 when the door 128 is closed (FIG. 7). Other shapes, sizes and locations for the breaches 154 are possible and contemplated by the present invention.

A safe 110 according to the present invention can be used in private, semi-public, and public locations. For example, the safe 110 can be used in homes, hotels, vehicles, and education institutions such as dormitory rooms. With the proliferation of devices such as the laptop or notebook personal computer, cell phones, PDA's, digital cameras, etc. and the personal information these items contain (e.g., passwords, pincodes, bank and credit card information, address books, class work, etc.), preventing information theft as well as preventing theft of the devices themselves have become more important to students as well as to their parents. Students currently have ineffective and inconvenient ways of protecting these items and most resort to carrying them around in their backpacks at all times or storing them in their cars, inviting damage or worse, theft. An example safe 110 according to the present invention takes little space in crowded dorm or residence rooms and allows the student quick and easy access to secure their valuables, as well as their identity. In another example, the students can safely insert items into the safe without opening the safe door and without showing the contents to people in the room who are not known to them. In addition if going away for a night or weekend, the students can safely recharge their electronic items without the fear of someone being able to remove small valuable items through the breach 154 (FIGS. 6-14). In one example, the breach 154 is made large enough to accommodate the cord rather than other devices (e.g., plug, coupler, noise suppressors, radio frequency interceptors etc.) attached to the cord. As such, in this example, the breach 154 is not large enough to allow a coupler, plug, noise suppressors, etc., to pass therethrough and this small size limits access into the safe via the breach 154 (port hole).

Further, the breaches 154 are situated on the housing 112 near the storage areas 152L, and safe bottom area 122, to allow power cables 156 to easily reach devices (e.g. laptop or notebook personal computer 164, cell phone 166) stored in those areas. In one example for storage area 152L, breach 154 (port hole) is positioned 8½ inches from bottom of storage area 152L so that cord 156 when placed in breach 154 will not be caught (pinched) between compartments 144 and 150 when door 128 is closed and secured. In one example of storage area 122, breach 154 (port hole) is positioned 2 inches from bottom of storage area 122 to allow power cable 156 to be attached to cell phone 166 outside of safe 110 and then power cable 156 can slide through opening 168 and into breach 154 and be protected by grommet 180. Such positioning of the breaches in relation to the storage areas 152L and 122 makes it possible to store and charge electrical devices placed in the safe, without tangled cords and the like.

Users (e.g., students) can store their belongings such as laptop or notebook computers, cell phones, MP3 players, PDA's, digital cameras, notebooks, mail, passports, bank and credit card statements; etc. in their dorm rooms or residences and have control over these valuables as well as their identity. The student can conveniently and safely deposit CD's, DVDs and credit cards into the safe 110 using the drop aperture 142 without damaging them or exposing the contents of safe 110. This is because with the safe door closed, the compartment 144 safely captures into the compartment 152R items inserted into the safe 110 from the aperture 142, and prevents such inserted items from dropping onto items stored in other storage areas (e.g., area 152L, area 122, etc.).

The safe 110 is designed for maximum space utilization and provides secure and private storage without using too much of the student's limited dorm or residence space. With a corkboard, mirror, dry eraser board, electronic eraser board or a combination of these on the front of the safe 110 it becomes unobtrusive. Preferably, the inside of storage areas 152L, 152R and 122, are covered with a shock absorbing rubber material, whereby the students need not worry about damage to their valuables. For example, with the aperture 142 and corresponding compartment 144 providing storage area 152R with a rubber surfaced shelf space, the students can insert their CDs, DVDs etc. into a safe without the fear of breakage.

Although the present invention has been described in considerable detail with regard to the preferred versions thereof, other versions are possible. Therefore, the appended claims should not be limited to the descriptions of the preferred versions contained herein.

What is claimed is:

1. A security safe comprising:
a housing defining a security enclosure, the housing including an opening into an interior of said enclosure for placing items into, and removing items from, said enclosure,
a door mechanism mounted to the housing for movement between opened and closed positions in relation to said opening, wherein in the closed position the door mechanism precludes access to said interior through said opening,
wherein the housing further includes an aperture for inserting items into said enclosure without moving said door mechanism into the opened position.

2. The safe of claim 1, wherein the aperture defines a slot through which items can be inserted into said enclosure.

3. The safe of claim 2, wherein the aperture defines a narrow slot to prevent reaching inside the safe by hand.

4. The safe of claim 1, wherein enclosure includes a breach providing access into the safe for passing at least a power cable therethrough for powering at least one electrical unit therein.
